(19) United States
(12) Patent Application Publication
(10) Pub. No.: US 2007/0011248 A1
(43) Pub. Date: Jan. 11, 2007

(54) Web publishing arrangement

(75) Inventors: Matti Kalervo, Jorvas (FI); Hannu Flinck, Helsinki (FI); Jan-Erik Ekberg, Helsinki (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/178,224

(22) Filed: Jul. 8, 2005

(51) Int. Cl. G06F 15/16

(52) U.S. Cl. 709/206

(57) ABSTRACT

A method for updating information content of a web page, wherein a network server operating the web page receives a request for a message template for the web page update from a terminal. The server transmits the message template including a set of editing commands to the terminal, whereafter an edited message template including information for updating the web page is received back from the terminal. Then the web page is updated according to the edited content of the message template.

### FIELD OF THE INVENTION

The invention relates to web publishing, and especially to an arrangement of transmitting update information to a web server.

### BACKGROUND OF THE INVENTION

The properties of the latest mobile station models include not only conventional telephone functions but also various multimedia functions that enable the creation and processing of multimedia files and their transmission on to other mobile stations or to a computer, for instance, for further processing. Mobile stations of this type typically comprise a digital camera, and the images produced by it can be transmitted to other telecommunications devices by using e-mail or a multimedia messaging service (MMS), for instance. The fact that such multimedia mobile stations have become common has made the sharing and distribution of images and other multimedia files between different terminals very popular.

A common solution for sharing and distributing multimedia files is so-called web publishing. Images or other multimedia files are stored on a web server, and other users are then granted access rights for browsing the multimedia files and downloading them to their terminals. Editing and manipulating the digital content of the multimedia files is typically carried out in a computer equipped with a set of sophisticated authoring and rendering tools, such as FrontPage® from Microsoft® or Netscape Composer®, which are designed with the assumption of a proper size of display and a Qwerty-keyboard.

For a user of a multimedia mobile station, there are situations wherein he or she would like share fresh multimedia files, like still images or recorded video or audio clips, shortly after capturing them. An example of such situation is a travel diary published on the Internet, whereby the timeliness of the information update is important. However, the PC-based editing arrangement described above is poorly suitable for a typical mobile device with a limited size of display and only a number keyboard with a laborious text input. Furthermore, the service authentication used in ordinary Web based systems may be too complicated to be used by a mobile user in a busy situation or non-compliant with the protocols supported by the mobile station. Accordingly, the web publishing usually takes place only after the user reaches a PC with the adequate tools. This delay may lower the value of the information. It is also possible that the user of the multimedia mobile station may have access rights to edit a content of a web page, but he or she doesn't have a PC and/or the required tools.

Thus, there is a need for a simple and a robust method for accessing a web page and publishing digital content therein in a timely way even with a simple multimedia mobile device.

### SUMMARY OF THE INVENTION

Now there is invented an improved method and technical equipment implementing the method, by which web publishing is easy to carry out even with a simple mobile device. Various aspects of the invention include methods, a network server, a terminal and computer programs, which is described below. Various embodiments of the invention are disclosed.

According to a first aspect, a method according to the invention is based on the idea that, in a network server, a request for a message template for a web page update is received from a terminal, whereby the message template including a set of editing commands is transmitted back to the terminal. Then an edited message template is received back from the terminal, which edited message template includes information for updating the web page. Then the web page is updated according to the edited content of the message template.

According to an embodiment, a user of the terminal is authenticated in response to receiving the request for the message template, and it is checked whether the user is authorized to update the web page.

According to an embodiment, the network server creates scripts for updating the web page on the basis of the edited content of the message template.

According to an embodiment, the message template is a MMS message or a SMS message.

According to an embodiment, the set of editing commands included in the message template are configured according to capabilities of the terminal receiving the message template.

According to an embodiment, the network server maintains a list of terminal users authorized to edit the web page, and the list is synchronized in accordance with a corresponding list maintained in a terminal of an administrative user.

According to an embodiment, the network server also maintains a list of terminal users willing to receive a notification of an update of the web page, and in response to updating the web page, a notification message is transmitted to at least one terminal user included in the list. The notification message is preferably a MMS message, a SMS message or an email message, and it includes an address of the web page in the form of a phone number.

According to a second aspect, another method according to the invention is based on the idea that, in a terminal, web page update information provided to a network server such that a message template including a set of editing commands is requested from the network server, and then in response to receiving the message template in the terminal, at least one editing function is carried out for the message template using at least one of said editing commands. Finally, the edited message template is transmitted back to the network server for updating a web page according to the edited content of the message template.

According to an embodiment, the editing commands used in the message template are parsed into a form compatible for updating a web page prior to transmitting the edited message template back to the network server.

The arrangement according to the invention provides significant advantages. A major advantage is that a simple-to-use web authoring tool is provided, which integrates preferably well with the existing wireless terminals, and which does not require other than the use of simple phone keypad. A further advantage is that a notification of the updated content is sent to a selected group of people, whereby the update is immediately recognized. A yet further advantage is that all addressing and other operations requiring user intervention are simple enough to be input via a phone keypad, which facilitates remarkably the usability of the system in a mobile environment.

According to a third aspect, there is provided a network server maintaining a web page, the network server comprising: means for receiving a request for a message template for a web page update from a terminal; means for transmitting the message template including a set of editing commands to the terminal; means for receiving an edited message template back from the terminal, the edited message template including information for updating the web page; and means for updating the web page according to the edited content of the message template.

According to a fourth aspect, there is provided a terminal for establishing a connection to a network server maintaining a web page, the terminal comprising: means for transmitting a request for a message template including a set of editing commands to the network server; means, responsive to receiving the message template in the terminal, for carrying out at least one editing function for the message template using at least one of said editing commands; and means for transmitting the edited message template back to the network server for updating a web page according to the edited content of the message template.

According to a fifth aspect, the operations of the network server may be carried out as a computer program product, stored on a computer readable medium and executable in a data processing device, the computer program product comprising: a computer program code section for receiving a request for a message template for a web page update from a terminal; a computer program code section for transmitting the message template including a set of editing commands to the terminal; a computer program code section for receiving an edited message template back from the terminal, the edited message template including information for updating the web page; and a computer program code section for updating the web page according to the edited content of the message template.

According to a sixth aspect, the operations of the terminal may be carried out as a computer program product, stored on a computer readable medium and executable in a data processing device, the computer program product comprising: a computer program code section for transmitting a request for a message template including a set of editing commands to the network server; a computer program code section, responsive to receiving the message template in the terminal, for carrying out at least one editing function for the message template using at least one of said editing commands; and a computer program code section for transmitting the edited message template back to the network server for updating a web page according to the edited content of the message template.

### BRIEF DESCRIPTION OF THE DRAWINGS

In the following, various embodiments of the invention will be described in more detail with reference to the appended drawings, in which

FIG. 1 shows a terminal device according to an embodiment of the invention in a simplified block diagram;

FIG. 2 shows a signalling chart of a web publishing method according to an embodiment of the invention; and

FIG. 3 shows network server according to an embodiment of the invention in a simplified block diagram.

### DETAILED DESCRIPTION OF EMBODIMENTS OF THE INVENTION

In the following, the invention will be illustrated by way of example by using embodiments that are especially related to sharing digital image files as web publishing. The invention is, however, not limited to (still) image files only, but the same procedure is also applicable to any update information, like text-only information, other multimedia files, such as digital video or audio files, and various document files.

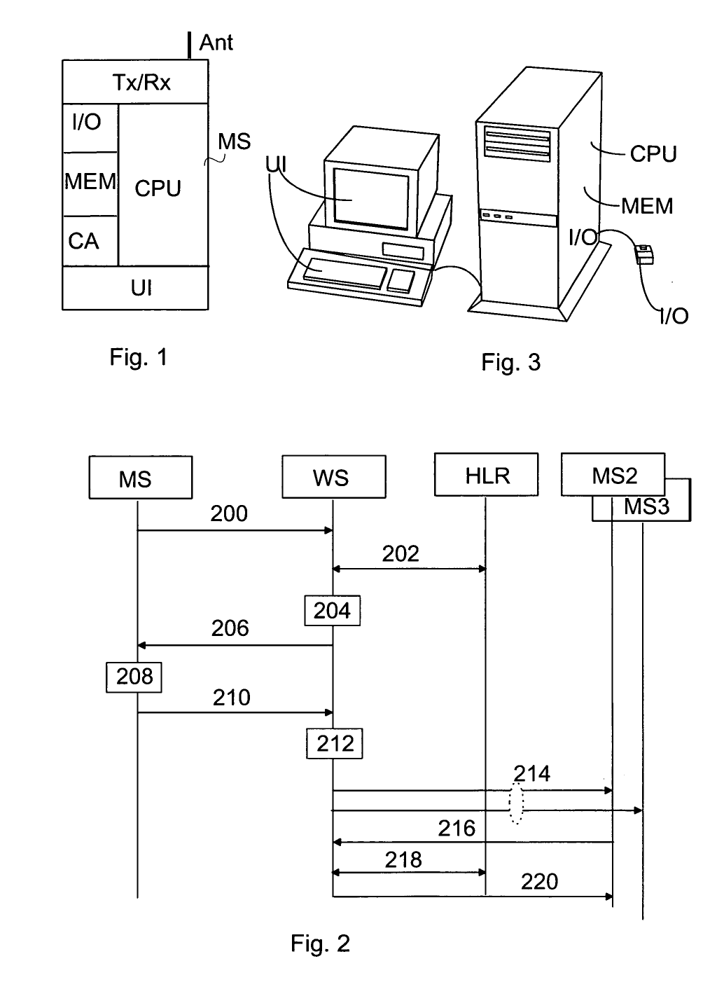

FIG. 1 shows a wireless terminal MS, such as a mobile station, which comprises camera functionality CA. A mobile station generally refers to a device comprising means for implementing wireless data transfer. Such devices include devices capable of data transfer with a public land mobile network, such as a GSM/GPRS network or a third-generation (e.g. 3GPP) network. It should be noted that the invention is also applicable to mobile stations equipped with a camera, in which the camera is not integrated to the mobile station, but the camera producing image information is attached to the mobile station over wire or wirelessly. It should yet further be noted that the invention is not limited to mobile stations, but it is also possible to apply the invention to portable or fixed personal computers, various mass memories, printers, and other electronic devices suited for file processing.

The mobile station MS comprises a central processing unit (CPU), memory (MEM), and I/O system (I/O). All necessary information is stored in the memory (MEM) of the device. The memory (MEM) comprises a read-only memory section formed for instance of a ROM memory, and a read-write memory section formed for instance of a RAM (Random Access Memory) and/or FLASH memory. Through the input/output system (I/O), the device communicates for instance with other devices, the network and the user. In particular, the I/O system comprises a transceiver Tx/Rx arranged to transmit and receive data transfer according to various wireless data transfer protocols through an antenna Ant. A user interface (UI), which is part of the input/output system (I/O), comprises the necessary interface, such as a display, keys, loudspeaker, and/or microphone, for communicating with the user. Information received from the different components of the device is transmitted to the central processing unit (CPU) that comprises one or more processors and processes the received information as desired.

The mobile station MS of FIG. 1 also comprises a camera CA able to function using any known digital imaging technique. The camera CA transforms light into electric charges in an image sensor, defines RGB values for dots and transforms them into a digital format. It should be noted that, in addition to still images, the camera CA is also able to store video images. The central processing unit CPU processes, for instance compresses, the digital-format image information and stores it into the memory MEM. The mobile station of FIG. 1 can, in addition to or instead of the camera, comprise means for generating and/or downloading digital sound material. This sound material can be music files compressed with an MP3 compression format, for instance.

The signalling diagram of FIG. 2 illustrates an arrangement according to an embodiment for transmitting multimedia files to a web server for publishing. The example of FIG. 2 uses digital still images recorded by a camera CA as the multimedia files. A request for web authoring is first transmitted (200) from a terminal MS to a web server WS. The request may be an SMS message or a phone call, for instance, to a service number in connection with the web server WS. A purpose of the request is to authenticate the user of the terminal MS, and to check whether he/she is authorized to edit any of the web pages maintained on the web server. The web server WS preferably has a plurality of service numbers connected to it such that each service number is linked with a particular web page. Alternatively, the request for web authoring may include an identification of the desired web page.

The web server authenticates (202) the user of the terminal MS in a subscriber database (HLR, Home Location Register) of a telecommunications system. Accordingly, the system preferably takes advantage of the existing authentication procedures of the telecommunications system. Once the user of the terminal MS has been authenticated, it is checked whether the user is authorized to edit the requested web page (204). The server WS preferably comprises a list of users, for example in the form of a phone book, authorized to edit the content of the particular web page, and the server checks if the authenticated user is included in the list.

If the user is authorized to edit the requested web page, the web server WS sends a web authoring message (206) to the terminal MS. The web authoring message is preferably a MMS message or a SMS message, which provides a template of the web page including an abbreviated version of the web page and a set of editing command tags to simplify the authoring of the web page. The abbreviated version of the web page may be a text-only version of the web page, or a graphical compressed image depending on the display and the processing capacity of the terminal. The set of the editing command tags should include only some basic commands enabling the user to edit the page, whereby a possible command set might be: <ADD text>, <ADD file>, <EDIT>, <DEL>, for instance. According to this embodiment, the terminal includes a parser for processing the commands, which parser should understand the commands and associate file attachment operations if requested. The parser is preferably carried out as a separate software program, e.g. a plug-in, loadable and executable in the terminal MS. The task of the parser is to translate the basic commands into complete instructions compatible with the web server authoring programs.

Then the user of the terminal carries out one or more editing functions (208). If the user wishes to include a still image recently captured with the camera, for instance, he or she will select the appropriate editing command from the web authoring message, which the terminal parses into a full command to include an image file. The file “include” operation in the terminal can be performed, for example, such that the terminal displays a list of image files available for attaching and the user makes the proper selection, which is reflected in the response message. Parsing the simple editing commands into full commands may preferably be carried out in a same way as in the pre-emptive text input mode: when the user inserts a basic command, the terminal guesses the rest of the command and displays a suggestion of a full command for the user to be accepted. The basic commands are preferably quite distinctive in comparison to each other in order to facilitate parsing the commands.

When the user of the terminal has carried out the desired editing functions, i.e. when the web-authoring message is ready, the updated content is sent back (210) to the web server WS using the same service number as with the request for web authoring. Accordingly, the user of the terminal handles only the simplified command sets and associated operations, and the parser then translates these commands and operations into more sophisticated operations compatible with the web server tools. The web server WS thus updates the particular web page (212) according to the editing commands of the web authoring response message received from the terminal MS. The web server WS generates appropriate scripts based on the editing commands and the scripts are used in performing the actual page update.

According to an embodiment, after the web page has been updated, the web server may transmit (214) a notification of the update to a predetermined group of terminals. The notification may be a MMS message, a SMS message or an email, for instance. The notification includes a unique address of the web page in the form of the service phone number or as a URL (Uniform Resource Locator) address accessible via a data network, whereby the web page can be connected to by simply establishing a data call to that number or a data connection to the URL address. This group of terminals preferably includes users who have indicated their interest in the content of the particular web page.

It is also possible that browsing the particular web page is subject to authentication, i.e. only a predetermined group of terminals is allowed to browse the page or browsing the page requires registration. This “browsing group” may be equal to the group of terminals included in the notification list. Consequently, in response to the notification transmitted to the predetermined group of terminals, at least one of the terminals (MS2) establishes (216) a connection to the web page for browsing the updated content. The web server authenticates (218) the user of the terminal MS2 in a subscriber database HLR, whereby the existing authentication procedures of the telecommunications system are transparent to the user. Following a successful authentication, the web server WS transmits the updated web page (220) to the terminal MS2.

The advantages provided by the various embodiments are apparent to a skilled person. A major advantage is that a simple-to-use web authoring tool is provided, which integrates preferably well with the existing wireless terminals, and which does not require other than the use of a simple phone keypad. A further advantage is that a notification of the updated content is sent to a selected group of people, whereby the update is immediately recognized. A yet further advantage is that all addressing and other operations requiring user intervention are simple enough to be input via a phone keypad. For instance, the addresses are not of the ordinary form of “www.name-of-the-server-too.long”, but just ordinary phone numbers. This facilitates remarkably the usability of the system in a mobile environment.

According to an embodiment, a user entitled to edit the page may, when submitting new information to the web page, define a sub-group of users from the notification list, to whom the notification of the update will be sent. This is advantageous, for instance, in a situation, wherein only a few of the terminal users on the notification list would be interested in the latest update.

Both the users entitled to edit the content of the particular web page and the users included in the notification list are preferably managed by a phone book application, whereby both lists of users are included at least in the web server WS and in the terminal of the page owner, i.e. the administrative user managing the access rights of possible other users as well. The lists of users should preferably be identical both in the web server WS and in the terminal of the page owner. Accordingly, the lists can be synchronized with an appropriate method, like using the SyncML (Synchronization Markup Language) data synchronization standard for enabling data synchronization between multiple devices. The administrative user manages both lists and he/she may add or delete users entitled to contribute to the particular web page, as well as add or delete users on the notification list. All changes in the lists are reflected to the web server via the synchronization arrangement.

According to an embodiment, the capabilities of the terminal may affect the complexity of the command set and the presentation form used in the web authoring message, i.e. the more advanced the terminal, the more enhanced may the command set be. For this purpose, the web server WS needs information about the capabilities of the terminal. Accordingly, this information can be stored within the web server, e.g., along with the phone book application, or the information can be transmitted to the web server in the request for web authoring.

According to another embodiment, the command set included in the web authoring message can be enhanced with layout hints, like <ADD UPPER LEFT>, <DELETE BOTTOM CENTER>, etc. Thus, the control of rendering the web page is given to the user of the terminal to a further extent instead of the web server.

The web server WS is connected to a telecommunications network, preferably to a mobile communications network, in order to provide the terminal connections to the web page on the basis of the service phone numbers. Thus, the web server WS may be operated by a mobile network operator, since the operations described above increase the applicability of MMS messages. Furthermore, the network operator may offer supplementary services related to web publishing. For instance, MMS-based picture groups can be created and shared with a selected group of people controlled by a SIM based authentication, or an alternative access control list (ACL). Moreover, the network operator may offer any Internet service, which could be rendered accessible via the authentication procedure described above. For example, access to a personal email account could be granted via the existing authentication procedures of the mobile communications system. Naturally, the web server WS may as well be operated by a service provider acquiring the telecommunications services from a network operator.

The web server WS may be a PC-based server computer known as such. Accordingly, the web server comprises, as illustrated in FIG. 3, memory MEM, a user interface UI, I/O means I/O for arranging data transmission with other devices, and one or more central processing units CPU comprising at least one processor. The memory MEM includes a non-volatile portion for storing the applications controlling the central processing unit CPU and other data to be stored and a volatile portion to be used for temporary data processing.

The steps according to the embodiments can be largely implemented with program commands executed in the central processing units CPU of the terminal MS illustrated in FIG. 1 and the web server WS illustrated in FIG. 3. Thus, said means for carrying out the method described above are typically implemented as computer software code. The computer software may be stored into any memory means, such as the hard disk of a PC or a CD-ROM disc, from where it can be loaded into the memory of mobile terminal. The computer software can also be loaded through a network, for instance using a TCP/IP protocol stack. It is also possible to use hardware solutions or a combination of hardware and software solutions for implementing the inventive means.

It will be evident to any person of skill in the art that the present invention is not limited solely to the above-presented embodiments, but it can be modified within the scope of the appended claims.

1. A method for updating information content of a web page, the method comprising:
receiving a request for a message template for a web page update from a terminal;
transmitting the message template including a set of editing commands to the terminal;
receiving an edited message template back from the terminal, the edited message template including information for updating the web page; and
updating the web page according to edited content of the message template.

2. The method according to claim 1, the method further comprising:
authenticating a user of the terminal in response to receiving the request for the message template; and
checking an authorization of the user to update the web page.

3. The method according to claim 1, the method further comprising:
creating scripts for updating the web page based on the edited content of the message template.

4. The method according to claim 1, wherein
the message template is a multimedia message service message or a short message service message.

5. The method according to claim 1, the method further comprising:
configuring the set of editing commands included in the message template according to capabilities of the terminal receiving the message template.

6. The method according to claim 1, the method further comprising:
maintaining a list of terminal users authorized to edit the web page; and
synchronizing the list in accordance with a corresponding list maintained in a terminal of an administrative user.

7. The method according to claim 1, the method further comprising:
maintaining a list of terminal users willing to receive a notification of an update of the web page; and
in response to updating the web page, transmitting a notification message to at least one terminal user included in the list.

8. The method according to claim 7, wherein
the notification message is a multimedia message service message, a short message service message or an email message; and
the notification message includes an address of the web page in a form of a phone number.

9. The method according to claim 7, the method further comprising:
authenticating a terminal user included in the list in response to receiving a request for browsing the web page.

10. A method for providing a network server with web page update information from a terminal, the method comprising:
requesting a message template including a set of editing commands from the network server;
in response to receiving the message template in the terminal, carrying out at least one editing function for the message template using at least one of said editing commands; and
transmitting an edited message template back to the network server for updating a web page according to edited content of the message template.

11. The method according to claim 10, the method further comprising:
parsing the editing commands used in the message template into a form compatible for updating a web page prior to transmitting the edited message template back to the network server.

12. The method according to claim 10, wherein
the set of editing commands includes at least a command for editing text of the web page and a command for including a file from a memory of the terminal in the web page.

13. The method according to claim 10, the method further comprising:
maintaining a list of terminal users authorized to edit the web page; and
in response to a change in the list, transmitting a command to synchronize a corresponding list maintained in the network server according to the change in the list maintained in the terminal.

14. A network server for maintaining a web page, the network server comprising:
means for receiving a request for a message template for a web page update from a terminal;
means for transmitting the message template including a set of editing commands to the terminal;
means for receiving an edited message template back from the terminal, the edited message template including information for updating the web page; and
means for updating the web page according to edited content of the message template.

15. The network server according to claim 14, wherein the network server is configured to
authenticate a user of the terminal in response to receiving the request for the message template; and
check an authorization of the user to update the web page.

16. The network server according to claim 14, wherein the network server is configured to
create scripts for updating the web page based on the edited content of the message template.

17. The network server according to claim 14, wherein
the message template is a multimedia message service message or a short message service message.

18. The network server according to claim 14, wherein the network server is configured to
adapt the set of editing commands included in the message template according to capabilities of the terminal receiving the message template.

19. The network server according to claim 14, wherein the network server is configured to
maintain a list of terminal users authorized to edit the web page; and
synchronize the list in accordance with a corresponding list maintained in a terminal of an administrative user.

20. The network server according to claim 14, wherein the network server is configured to
maintain a list of terminal users willing to receive a notification of an update of the web page; and
in response to updating the web page, transmit a notification message to at least one terminal user included in the list.

21. The network server according to claim 20, wherein
the notification message is a multimedia message service message, a short message service message or an email message; and
the notification message includes an address of the web page in a form of a phone number.

22. The network server according to claim 20, wherein the network server is configured to
authenticate a terminal user included in the list in response to receiving a request for browsing the web page.

23. A terminal for establishing a connection to a network server maintaining a web page, the terminal comprising:
means for transmitting a request for a message template including a set of editing commands to the network server;
means, responsive to receiving the message template in the terminal, for carrying out at least one editing function for the message template using at least one of said editing commands; and
means for transmitting an edited message template back to the network server for updating a web page according to edited content of the message template.

24. The terminal according to claim 23, further comprising:
means for parsing the editing commands used in the message template into a form compatible for updating a web page prior to transmitting the edited message template back to the network server.

25. The terminal according to claim 23, further comprising:
means for editing text of the web page and means for including a file from a memory of the terminal in the web page.

26. The terminal according to claim 23, further comprising:
a memory means for maintaining a list of terminal users authorized to edit the web page; and
means, responsive to a change in the list, for transmitting a command to synchronize a corresponding list maintained in the network server according to the change in the list maintained in the terminal.

27. A computer program product, stored on a computer readable medium and executable in a data processing device, for maintaining a web page, the computer program product comprising:
a computer program code section for receiving a request for a message template for a web page update from a terminal;
a computer program code section for transmitting the message template including a set of editing commands to the terminal;
a computer program code section for receiving an edited message template back from the terminal, the edited message template including information for updating the web page; and
a computer program code section for updating the web page according to edited content of the message template.

28. A computer program product, stored on a computer readable medium and executable in a data processing device, for providing a network server with web page update information, the computer program product comprising:
a computer program code section for transmitting a request for a message template including a set of editing commands to the network server;
a computer program code section, responsive to receiving the message template in the terminal, for carrying out at least one editing function for the message template using at least one of said editing commands; and
a computer program code section for transmitting an edited message template back to the network server for updating a web page according to edited content of the message template.
